(19) United States
(12) Patent Application Publication
(10) Pub. No.: US 2025/0260256 A1
(43) Pub. Date: Aug. 14, 2025

(54) WATER PURIFICATION ROBOT, STATION FOR WATER PURIFICATION ROBOT, AND SMART WATER QUALITY MANAGEMENT SYSTEM USING THE SAME

(71) Applicant: ECOPEACE CO., LTD., Gwangju (KR)

(72) Inventor: In Won CHAE, Damyang-gun, Jeollanam-do (KR)

(73) Assignee: ECOPEACE CO., LTD., Gwangju (KR)

(21) Appl. No.: 18/859,225

(22) PCT Filed: Dec. 2, 2022
(86) PCT No.: PCT/KR2022/019456

§ 371 Date: Oct. 23, 2024

(30) Foreign Application Priority Data
Apr. 27, 2022 (KR) 10-2022-0052014
Apr. 27, 2022 (KR) 10-2022-0052015

(51) Int. Cl. H02J 7/35; C02F 1/00; C02F 1/40; C02F 103/00; H02S 10/00

(52) U.S. Cl. CPC H02J 7/35; C02F 1/004; C02F 1/008; C02F 1/40; C02F 2103/007; C02F 2201/008; C02F 2201/009; C02F 2209/006; C02F 2209/36; H02S 10/00

(57) ABSTRACT

The present invention relates to a water purification robot capable of easily controlling a direction during autonomous driving in reservoirs, dams, etc. and removing algae by measuring water quality in real time, collecting water at a specific water collection point and water collection depth to improve accuracy of water quality measurement, and purifying water quality by circulating water while charging a water purification robot and managing the water purification robot in an unmanned way to help to improve the water quality, a station for a water purification robot, and a smart water quality management system using the same.

### TECHNICAL FIELD

The present invention relates to a water purification robot, a station for a water purification robot, and a smart water quality management system using the same, and more particularly, to a water purification robot capable of easily controlling a direction thereof while performing autonomous driving in reservoirs, dams, etc., removing algae after measuring water quality in real time, collecting water at specific water collection points and water collection depths to improve accuracy of water quality measurement, purifying water quality by circulating water while charging the water purification robot, and being managed in an unmanned way to help to improve the water quality, the station for the water purification robot, and the smart water quality management system using the same.

### BACKGROUND ART

Recently, water temperature has increased due to environmental pollution, causing emergence of algae in reservoirs and dams. In particular, the emergence of algae arises severely in the summer and kills fish and aquatic plants, thereby destroying the ecological environment and causing severe odor.

Generally, the emergence of algae is a phenomenon in which phytoplankton living in eutrophicated lakes, reservoirs, dams, slowly-flowing rivers, etc. in the summer multiply in large quantities and float on a water surface, thereby changing a water color to green.

The emergence of algae basically arises due to eutrophication of water bodies, especially excessive influx of phosphorus. When phosphorus is introduced in a state in which nitrogen has been introduced mainly through fertilizers spread on surrounding farmland, etc., specific cyanobacteria or algae grow in large quantities. When the environment suitable for the growth of a specific species continues, the number of algae or cyanobacteria cells increases explosively as a result of cell division to change the water color.

When the algae proliferate, the amount of oxygen dissolved in the water decreases to cause fish to die in droves and water to smell rotten, which can cause damage to fishing industries, nearby villages, etc. In addition, drinking green-colored water having a lot of toxic blue-green algae may cause liver damage, vomiting, and abdominal pain, and drinking a lot of the green-colored water may lead to death. Moreover, an ecosystem of a body of water may be damaged, causing problems in a food chain structure.

Therefore, various methods are being used to resolve problems related to algae and manage water quality so that they satisfy environmental standards or a usage purpose of water set for a body of water, such as a reservoir, dam, lake, and river.

Various methods are being developed to remove the algae. Examples of physical methods may include dilution by using water from other water bodies, artificial destruction of stratification, destruction of air sacs using ultrasound, physical removal of cyanobacteria, etc., examples of biological methods include methods such as biological control using a trophic cascade response to introduce larger fish that eat small fish or remove all species of small fish that feed on zooplankton when small fish that feed on zooplankton are at a top level, and examples of chemical methods include algaecide treatment.

In addition, to solve the algae phenomenon, yellow soil has been sprinkled to float on the water surface, blocking sunlight to prevent the prevent algae from proliferating, or the yellow soil is entangled with the algae to sink to the bottom. However, this is only a temporary measure. Accordingly, there is a problem in that this may affect other aquatic organisms and disrupt the ecosystem.

To solve this problem, as described in Korean Laid-Open Patent No. KR10-2015-0067659A (Published on Jun. 18, 2015), a water purification device for preventing and removing algae in a lake includes a control means that controls charging and power generation and a speed of fluid circulation means, a buoyant body means that includes a suction passage for suctioning water and algae from a water surface and an outlet connected to the suction passage in the center thereof to make the algae float on the water surface by buoyancy and suction the algae remaining on the water surface, a moving pipe that is installed in the outlet to move water from the water surface to below the water surface, a fluid circulation means that is installed in the buoyant body means to move the water from the water surface to below the water surface using wind power, a power generation means that generates and stores electricity based on a rotational force of the fluid circulation means, a negative ion generating means that is connected to the power generation means and fixedly installed in the moving pipe to generate negative ions and coagulate the algae contained in the water surface, and a fixing means that connects a weight to the buoyancy body means with a loop to suspend the buoyancy body means on the water surface.

In addition, various methods are being used, such as a method of using a water wheel for water circulation or a method of operating an algae removal boat that installs and operates a device for suctioning, filtering out, and retrieving algae via a boat.

However, the conventional methods may help remove the algae and suppress the algae phenomenon, but have a problem in that the maintenance costs are high compared to the water purification performance.

In particular, in the case of the aforementioned patent, since the water purification device is fixed to the surface of water and removes algae only by relying on the flow of water, there is a problem in that missed spots may arise, and not only is it impossible to efficiently manage water quality, but since multiple water purification devices should be installed at regular intervals, there is a problem in that installation and maintenance costs may increase.

In addition, since it is difficult for a water wheel for water circulation, a boat, etc. to freely change direction while floating on a water surface, even when being driven autonomously, spots having algae which are missed may easily emerge, which reduces the efficiency of water purification.

Meanwhile, an algae removal device, a water purification robot, etc. used to remove algae in reservoirs or dams and purify water quality use energy produced from sunlight for operation, so they may be easily affected by weather and the like, and the capacity of a battery that stores the produced energy is limited. As a result, there is a problem in that the operation is not possible when the battery is discharged or the energy cannot be produced due to overcast weather.

Accordingly, there is a need for a technology capable of monitoring water quality of reservoirs and dams to purify the water quality and easily managing a water purification robot based on charging the water purification robot before the water purification robot is discharged.

### DISCLOSURE

### Technical Problem

The present invention has been proposed to solve the above-described problems and provides a water purification robot capable of autonomously moving in front-rear and left-right directions and freely adjusting directions in a reservoir, a dam, etc., a station for a water purification robot, and a smart water quality management system using the same.

In addition, the present invention provides a water purification robot capable of improving a water purification function by measuring water quality of a reservoir, a dam, etc. in real time to identify an area at risk related to algae and remove the algae, a station for a water purification robot, and a smart water quality management system using the same.

In addition, the present invention provides a water purification robot capable of measuring water quality and identifying algae species by collecting water from a specific water collection point and water collection depth, a station for a water purification robot, and a smart water quality management system using the same.

In addition, the present invention provides a water purification robot capable of predicting an emergence of algae in a reservoir or a dam by utilizing big data, a station for a water purification robot, and a smart water quality management system using the same.

In addition, the present invention provides a water purification robot capable of storing electricity produced through solar power generation in an energy storage system (ESS) while floating on a reservoir or a dam and charging the water purification robot at a necessary time, a station for a water purification robot, and a smart water quality management system using the same.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

### Technical Solution

A water purification robot according to the present invention to achieve the above purpose includes a current situation unit (130) that includes an image capturing module mounted on a base part (110) floating on a water surface of a reservoir to capture a water surface image and an underwater image and a water quality measurement module for measuring water quality of the reservoir, a driving unit (140) that is mounted under the base part (110) and includes four motors for driving that allow a directional change to be made in all directions, a algae removal unit (150) that filters algae in water introduced by the driving of the driving unit (140) and discharges purified water, and a robot control unit (180) that controls the driving unit (140) by analyzing the water surface image and the underwater image while driving along a preset driving path to generate an avoidance path according to whether there is an obstacle and controls the algae removal unit (150) by comparing water quality measurement data with a preset normal degree of algae concentration.

As one embodiment, the algae removal unit (150) may include water inflow cases (151) having a predetermined length that are installed on each side surface of the base part (110) to introduce the water containing the algae into a plurality of water inflow holes (152) formed in a longitudinal direction and primarily filter the water, a filter pipe (153) having a predetermined length that is installed in the water inflow case (151) and provided with the plurality of water inflow holes (152) to introduce the primarily filtered water and secondarily filters the primarily filtered water, a water purification robot filter (155) that is installed under the base part (110) to filter the algae in the secondarily filtered water and discharge the purified water into the reservoir, and a flow pipe (161) that connects the water purification robot filter (155) and the filter pipe (153) to introduce the secondarily filtered water.

As one embodiment, the water purification robot may further include a water quality management unit (190) that collects water from a preset water collection point and water collection depth and analyzes water quality, in which the water quality management unit (190) may include a suction pipe (191) having a predetermined length that suctions the water from the reservoir, a lift pump (192) that is connected to the suction pipe (191) for pumping the water, and a water collection tank (193) that has a water collection space formed to be filled with the water pumped from the suction pipe (191), and it is preferable that the water collection tank (193) may have a plurality of baffles (194) that are formed on inner surfaces facing each other to alternately protrude toward the water collection space and partition the water collection space into an inflow zone, a water quality analysis zone, and a discharge zone.

As one embodiment, the robot control unit (180) may further include a water quality management unit (190) that generates a water collection command signal including information related to a water collection point and a water collection depth of the reservoir and collects the water according to the water collection command signal received from the robot control unit (180) to analyze the water quality, the water quality management unit (190) may include a suction pipe (191) having a predetermined length that suctions the water from the reservoir, a lift pump (192) that is connected to the suction pipe (191) for pumping the water, and a water collection tank (193) that has a water collection space formed to be filled with the water pumped from the suction pipe (191), and the water collection tank (193) may have a plurality of baffles (194) that are formed on inner surfaces facing each other to alternately protrude toward the water collection space and partition the water collection space into an inflow zone, a water quality analysis zone, and a discharge zone.

As one embodiment, the robot control unit (180) may include an image storage module (181) that receives and stores the water surface image and the underwater image, an image analysis module (182) that analyzes the water surface image and the underwater image and determines whether there is the obstacle to generate obstacle information, a current location measurement module (183) that measures a current location through a global positioning system (GPS) to generate current location information, a path generation module (184) that generates an avoidance path to autonomously be driven by avoiding the obstacle in a driving path using the current location information and the obstacle information, a motor control module (185) that drives the driving unit (140) to be driven along the driving path and the avoidance path, an algae purification module (186) that compares the water quality measurement data received from the water quality measurement module with the preset normal degree of algae concentration to operate the algae removal unit (150), a water collection command module (187) that generates a water collection command signal including information related to a water collection point and a water collection depth and transmits the generated water collection command signal to the water quality management unit (190), and a water quality management storage module (188) that stores water quality analysis data received from the water quality management unit (190).

A station for a water purification robot according to the present invention includes a station main body part (210) having a predetermined size, a solar power generation unit (220) that is installed on an upper surface of the station main body part (210) to convert sunlight into electric energy and produce the electric energy, an energy storage system (ESS) unit (230) that stores the electric energy produced by the solar power generation unit (220), a docking unit (240) that includes a charging terminal that is formed on a side surface of the station main body part (210) and comes into contact with a charging socket of the water purification robot (100) to charge the water purification robot (100), a robot detection unit (250) that detects a docking status of the docking unit (240) and the water purification robot (100), and a station control unit (280) that generates a charging command signal according to whether the docking status of the water purification robot (100) is normal through the robot detection unit (250) and provides the generated charging command signal to the docking unit (240), in which the water purification robot (100) includes a current situation unit (130) that includes an image capturing module mounted on a base part (110) floating on a water surface of a reservoir to capture a water surface image and an underwater image and a water quality measurement module for measuring water quality of the reservoir, a driving unit (140) that is mounted under the base part (110) and includes four motors for driving that allow a directional change to be made in all directions, a algae removal unit (150) that filters algae in water introduced by the driving of the driving unit (140) and discharges purified water, and a robot control unit (180) that controls the driving unit (140) by analyzing the water surface images and the underwater image while driving along a preset driving path to generate an avoidance path according to whether there is an obstacle and controls the algae removal unit (150) by comparing water quality measurement data with a preset normal degree of algae concentration.

As one embodiment, it is preferable that the station control unit (280) may include a station communication module (281) that communicates with the water purification robot (100), a docking status determination module (282) that determines whether the docking status of the water purification robot (100) is normal based on whether the charging socket of the water purification robot (100) comes into contact with the charging terminal of the docking unit (240) through the robot detection unit (250), a charging command module (283) that generates a charging command signal and provides the generated charging command signal to the docking unit (240) when the docking status of the water purification robot (100) is normal, and a re-docking request module (284) that generates a re-docking request signal and provides the generated re-docking request signal to the water purification robot (100) when the docking status of the water purification robot (100) is abnormal.

As one embodiment, the station may further include a circulation pump unit (260) that is connected to a suction pipe for suctioning water from the reservoir to pump the water, and a water purification unit (270) that filters algae in the water suctioned through the circulation pump unit (260) and discharges purified water.

As one embodiment, the station control unit (280) may include a pollution level measurement module 285 that measures the water quality of the reservoir to generate a water pollution level, and a water purification command module (286) that generates a water purification command signal to drive the circulation pump unit (260) so as to suction the water from the reservoir when the generated water pollution level exceeds a preset normal water pollution level and transmits the generated water purification command signal to the circulation pump unit (260).

As one embodiment, the station control unit (280) may include a pollution prediction module (287) that predicts whether the algae will emerge according to pre-stored weather information for a current location and the water pollution level using pre-stored precursory information of an emergence of algae and generates water pollution prediction information and transmits the generated water pollution prediction information to the water purification command module (286).

As one embodiment, the solar power generation unit (220) may further include a plurality of solar cells, a support frame that supports the solar panels, and a hinge axis that connects the solar cells and the support frame so that the solar cells are rotatably connected to the support frame, and the station control unit (280) may include a sun location calculation module (288) that calculates an altitude and an azimuth of the sun through the pre-stored current location to generate information related to the position of the sun and an angle adjustment module 289 that generates a driving signal for adjusting an angle of the solar power generation unit (220) using the generated information related to the position of the sun and provides the driving signal to the solar power generation unit (220).

A smart water quality management system according to the present invention includes a control server (300) that monitors water quality measurement data of a reservoir and predicts whether algae will emerge according to water quality analysis data and weather information data using pre-stored precursory information of an emergence of algae to generate algae prediction information and a water purification robot (100) that generates water quality measurement data to be transmitted to the control server (300), sets a driving path in advance for driving according to the algae prediction information through current location information, includes an avoidance path in the preset driving path according to whether there is an obstacle by capturing a water surface image and an underwater image of the reservoir, and filters the algae in the water introduced while autonomously driving along the driving path and discharges purified water, in which the water purification robot (100) includes a current situation unit (130) that includes an image capturing module mounted on a base part (110) floating on a water surface of the reservoir to capture a water surface image and an underwater image and a water quality measurement module for measuring water quality of the reservoir, a driving unit (140) that is mounted under the base part (110) and includes four motors for driving that allow a directional change to be made in all directions, a algae removal unit (150) that filters algae in water introduced by the driving of the driving unit (140) and discharges purified water, and a robot control unit (180) that controls the driving unit (140) by analyzing the water surface image and the underwater image while driving along a preset driving path to generate an avoidance path according to whether there is an obstacle and controls the algae removal unit (150) by comparing water quality measurement data with a preset normal degree of algae concentration.

As one embodiment, the water purification robot (100) may include a base part (110) that floats on the surface of the reservoir, a solar panel part (120) that is installed above the base part (110) to convert sunlight into electrical energy, a bumper part (170) that is installed on the base part (110) to be located between the algae removal unit (150) and buffers external impact, a robot control unit (180) that generates a water collection command signal including information related to a water collection point and a water collection depth of the reservoir, and a water quality management unit (190) that collects water from the water collection point and the water collection depth according to the water collection command signal received from the robot control unit (180) and analyzes water quality.

As one embodiment, the algae removal unit (150) may include water inflow cases (151) having a predetermined length that are installed on each side surface of the base part (110) to introduce the water containing the algae into a plurality of water inflow holes (152) formed in a longitudinal direction and primarily filter the water, a filter pipe (153) having a predetermined length that is installed in the water inflow case (151) and provided with the plurality of water inflow holes (152) to introduce the primarily filtered water and secondarily filters the primarily filtered water, a water purification robot filter (155) that is installed under the base part (110) to filter the algae in the secondarily filtered water and discharge the purified water into the reservoir, and a flow pipe (161) that connects the water purification robot filter (155) and the filter pipe (153) to introduce the secondarily filtered water.

As one embodiment, the robot control unit (180) may include an image storage module (181) that receives and stores the water surface image and the underwater image, an image analysis module (182) that analyzes the water surface image and the underwater image and determines whether there is the obstacle to generate obstacle information, a current location measurement module (183) that measures a current location through a global positioning system (GPS) to generate current location information, a path generation module (184) that generates an avoidance path to autonomously be driven by avoiding the obstacle in a driving path using the current location information and the obstacle information, a motor control module (185) that drives the driving unit (140) to drive along the driving path and the avoidance path, an algae purification module (186) that compares the water quality measurement data received from the water quality measurement module with the preset normal degree of algae concentration to operate the algae removal unit (150), a water collection command module (187) that generates a water collection command signal including information related to a water collection point and a water collection depth and transmitting the generated water collection command signal to the water quality management unit (190), and a water quality management storage module (188) that stores water quality analysis data received from the water quality management unit (190).

As one embodiment, the control server (300) may include a server communication unit (310) that communicates with the water purification robot (100), an image database DB unit (320) that stores the water surface image and the underwater image received from the water purification robot (100) through the server communication unit (310), a monitoring unit (330) that displays and monitors the stored water surface image and underwater image, a water collection request unit (340) that sets the water collection point and the water collection depth for collecting the water from the reservoir and transmits a generated water collection request signal to the water purification robot (100), a water quality DB unit (350) that stores water quality analysis data received from the water purification robot (100), a weather information acquisition unit (360) that acquires weather information data corresponding to location information of the reservoir, and an algae prediction unit (370) that predicts whether the algae will emerge by matching the water quality analysis data and weather information data with a pre-stored precursor of an emergence of algae and generates algae prediction information and transmit the generated algae prediction information to the water purification robot (100).

A method of managing water quality using a smart water quality management system according to the present invention includes an image capturing operation in which a water purification robot (100) autonomously drives along a preset driving path to capture a water surface image and an underwater image of a reservoir and generate the water surface image and the underwater image, an image analysis operation in which the water purification robot (100) analyzes the water surface images and the underwater image and generates an avoidance path according to whether there is an obstacle, a self-driving operation in which the water purification robot (100) extracts current location information using GPS and autonomously drives along the driving path or the avoidance path, a water quality measurement operation in which the water purification robot (100) measures water quality in real time and generates water quality measurement data, an algae removal operation in which, when the water quality measurement data in the water purification robot (100) exceeds a preset normal degree of algae concentration, water is introduced during driving and the algae is filtered and purified water is discharged, a water collection request operation in which a control server (300) transmits a water collection request signal setting a water collection point and a water collection depth to the water purification robot (100), a water quality analysis operation of receiving the water collection request signal from the water purification robot (100), collecting water from the water collection point and the water collection depth, and then generating water quality analysis data measuring water quality and transmitting the generated water quality analysis data to the control server (300), a weather information acquisition operation of obtaining weather information data using location information of the reservoir from the control server (300), and an algae prediction operation of generating algae prediction information by predicting an emergence of algae when the water quality analysis data and the weather information data from the control server (300) correspond to pre-stored precursory information of the emergence of algae and transmitting the algae prediction information to the water purification robot (100) to operate the water purification robot (100).

### Advantageous Effects

As described above, according to the present invention, since the water purification robot can autonomously move in all directions, i.e., front-rear and left-right directions in reservoirs, dams, etc., and move freely while avoiding obstacles on a water surface and underwater of the reservoirs, the dams, etc., and as a result, can operate efficiently and economically using a small number of devices relative to the area of the reservoirs, the dams, etc., and remove algae in missed spots as well as areas at risk, it is possible to improve a water purification function while automatically managing water quality.

In addition, by measuring the water quality of the reservoirs, the dams, etc. in real time to quickly remove the algae, it is possible to improve the water purification function, easily manage the reservoir or dam, and prevent destruction of an ecosystem.

In addition, by collecting water at a specific water collection point and water collection depth, it is possible measure water quality for each water depth, improve the accuracy of measurement of the water quality such as water temperature, and easily manage the water quality.

In addition, by utilizing big data to predict the emergence of the algae and making quick responses such as the removal of the algae to collect initial response strategies, it is possible to minimize damage due to the algae and prevent water pollution from spreading.

In addition, by storing electricity produced through solar power generation in an energy storage system (ESS) while floating in the reservoirs, the dams, etc. to charge the water purification robot regardless of time, weather, etc. so that the water purification robot can be maintained and accidents, such as the stoppage of operation of the water purification robot, can be prevented in advance, it is possible to efficiently operate the water purification robot. In particular, by managing the water purification robot in an unmanned manner, it is possible to improve the convenience of a manager thereof.

In addition, it is possible to help purify water quality by circulating water in the reservoirs, the dams, etc., help shorten the time for managing the water quality of the large area of water, and improve the efficiency of the water purification by purifying water twice.

### DESCRIPTION OF DRAWINGS

FIG. 1 is a diagram illustrating a water purification robot according to an embodiment of the present invention.

FIG. 2 is a cross-sectional view of a water inflow case or a filter pipe of an algae removal unit of a water purification robot according to an embodiment of the present invention.

FIG. 3 is a diagram illustrating a filter of the algae removal unit of the water purification robot according to an embodiment of the present invention.

FIG. 4 is a robot control unit of the water purification robot according to an embodiment of the present invention.

FIG. 5 is a cross-sectional view of a water quality management unit of the water purification robot according to an embodiment of the present invention.

FIG. 6 is a diagram illustrating a station for water purification according to an embodiment of the present invention.

FIG. 7 is a block diagram of a configuration of the station for water purification according to an embodiment of the present invention.

FIG. 8 is a diagram illustrating a water purification unit of the station for water purification according to an embodiment of the present invention.

FIG. 9 is a diagram illustrating a process of purifying water quality through the water purification unit of the station for water purification according to an embodiment of the present invention.

FIG. 10 is a diagram illustrating a station control unit of the station for water purification according to an embodiment of the present invention.

FIG. 11 is a diagram illustrating a smart water quality management system according to an embodiment of the present invention.

FIG. 12 is a diagram illustrating a control server of the smart water quality management system according to an embodiment of the present invention.

FIG. 13 is a diagram illustrating a method of managing water quality using the smart water quality management system according to an embodiment of the present invention.

### BEST MODE

Hereinafter, a water purification robot, a station for a water purification robot, and a smart water quality management system using the same according to the present invention are described in detail with reference to the accompanying drawings.

When adding quotation marks to components of the above drawings, identical components are given the same symbols as often as possible even if they are illustrated on different drawings, and detailed descriptions of well-known functions and configurations that may unnecessarily obscure the gist of the present invention will be omitted. In addition, directional terms such as “upper portion,” “lower portion,” “front,” “back,” “front end,” “forward,” “rear end,” etc. are used in relation to orientations of the disclosed drawing(s). Since components of embodiments of the present invention may be positioned in various orientations, directional terms are used for illustrative purposes and not for limitation.

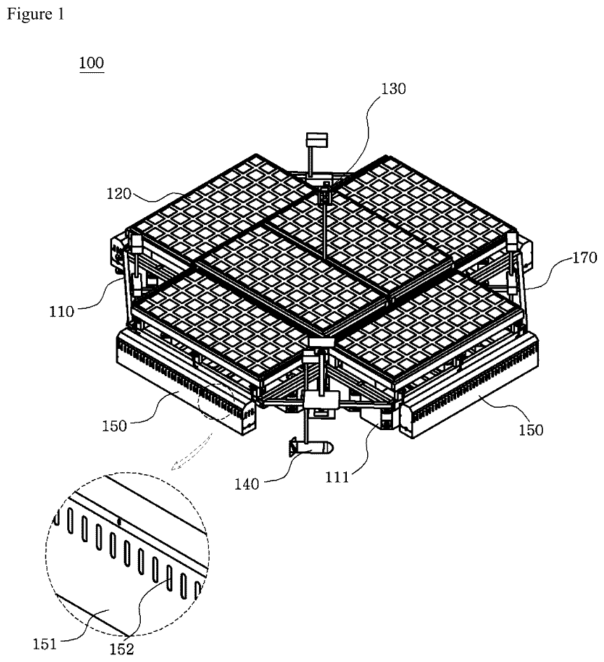

A water purification robot according to a preferred embodiment of the present invention will be described below with reference to FIG. 1.

A water purification robot 100 may include a base part 110 that floats on a water surface of a reservoir, a solar panel part 120 that is installed above the base part 110 to convert sunlight into electrical energy, a current situation unit 130 that includes an image capturing module (not illustrated) mounted on the base part 110 to capture water surface images and an underwater images and a water quality measurement module (not illustrated) for measuring water quality of the reservoir, a driving unit 140 that is mounted under the base part 110 for driving that allow a directional change to be made in all directions, algae removal units 150 that filter algae in the water introduced by the driving of the driving unit 140 to discharge purified water, a bumper part 170 that is installed on the base part 110 to be located between the algae removal units 150 and buffers external impact, and a robot control unit 180 that controls the driving unit 140 by analyzing the water surface images and the underwater images to generate avoidance paths according to whether there are obstacles while driving along a preset driving path and controls the algae removal units 150 by comparing water quality measurement data with a preset normal degree of algae concentration.

In the case of receiving a water collection command signal from the robot control unit 180, the water purification robot 100 may further include a water quality management unit 190 that collects water from a water collection point and a water collection depth according to the water collection command signal to measure water quality.

The base part 110 may be formed in an octagon shape of a predetermined size so as to receive less air resistance, but is not limited thereto, and may be formed in various shapes such as a circle.

In addition, the base part 110 should have a plurality of buoyant bodies 111 provided at the lower portion thereof so that it may float on the water surface of the reservoir. In this case, it is preferable that the buoyant body 111 be arranged and configured in each area when the lower portion of the base part 110 is divided into four quadrants.

The solar panel part 120 is installed above the base part 110 and is composed of a plurality of solar panels to convert sunlight into electrical energy.

The solar panel part 120 has the effect of enabling efficient and environmentally-friendly operation.

A battery unit (not illustrated) for storing the electrical energy generated from the solar panel part 120 should be further configured.

The current situation unit 130 is mounted on the base part 110 and may measure the current situation of the water surface and underwater of the reservoir.

The current situation unit 130 includes an image capturing module (not illustrated) for capturing the water surface images and the underwater images of the reservoir and a water quality measuring module (not illustrated) for measuring the water quality of the reservoir.

The image capturing module may include a water camera for capturing images of the water surface of the reservoir and an underwater camera for capturing images of the underwater of the reservoir.

The water camera is preferably installed at a center of the upper portion of the base part 110. In addition, the underwater camera is preferably installed under the base part 110 and is preferably installed at each area when the base part 110 is divided into four quadrants to minimize blind spots.

The image capturing module generates the water surface images of the reservoir captured by the water camera and generates the underwater images of the reservoir captured by the underwater camera.

The water quality measurement module is for measuring the water quality of the reservoir, and a water quality measurement sensor may be used.

In addition, the water quality measurement module measures the water quality of the reservoir in real time to generate water quality measurement data. In this case, it is preferable that the water quality measurement data include information related to a degree of algae concentration and the like.

The driving unit 140 includes four motors mounted under the base part 110. That is, the driving unit 140 has a first motor, a second motor, a third motor, and a fourth motor provided in each area when the lower portion of the base part 110 is divided into four quadrants, and directional changes can be made in all directions due to each of the motors.

The water purification robot may drive frontward, backward, leftward, and rightward using the four motors configured in the driving unit 140, and thus the direction may easily be changed when the water purification robot is driven, thereby minimizing the missed spots in monitoring the reservoir.

In addition, the driving unit 140 may further include a plurality of cameras, radar sensors, lidar sensors, a global positioning system (GPS), etc. so that the front, back, left, and right can be perceived.

The algae removal units 150 are configured to remove algae from water while driving through the driving unit 140.

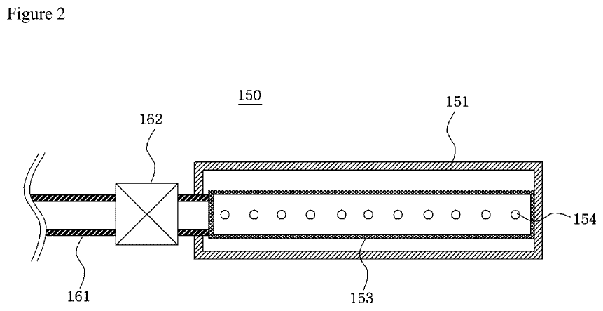

The algae removal units 150 are described below with reference to FIG. 2.

The algae removal units 150 are for filtering the algae in water introduced by the driving of the driving unit 140 and discharging purified water and may include water inflow cases 151 having a predetermined length that are installed on each side surface of the base part 110 to introduce the water containing the algae into a plurality of water inflow holes 152 formed in a longitudinal direction and primarily filter the water, a filter pipe 153 having a predetermined length that is installed in the water inflow case 151 and provided with the plurality of water inflow holes 152 to introduce the primarily filtered water and secondarily filters the primarily filtered water, a water purification robot filter 155 that is installed under the base part 110 to filter the algae in the secondarily filtered water and discharge the purified water into the reservoir, and a flow pipe 161 that connects the water purification robot filter 155 and the filter pipe 153 to introduce the secondarily filtered water.

The water inflow case 151 may be formed into a square bar shape having a predetermined length and has a plurality of water inflow holes 152 formed in the longitudinal direction.

In this case, water up to 1.5 cm above the water surface is introduced into the water inflow hole 152 of the water inflow case 151.

The water inflow case 151 may be provided with the plurality of water inflow holes 152 to introduce water containing algae into the water inflow holes 152 and primarily filter the water, thereby preventing large floating substances from being introduced, foreign substances from being accumulated, and preventing malfunctions, etc. in advance.

The water inflow case 151 is preferably installed on the side surface of the base part 110. In this case, when the base part 110 has an octagonal shape, it is preferable that the water inflow case 151 not be installed on adjacent side surfaces among the side surfaces of the base part 110 with respect to an installation surface where the water inflow case 151 is installed. In other words, when the base part 110 has an octagonal shape, the side surface of the base part 110 may be divided into four installation surfaces and four non-installation surfaces.

The filter pipe 153 is a pipe having a predetermined length and is installed inside the water inflow case 151.

A plurality of water filter holes 154 are formed in the longitudinal direction of the filter pipe 153 and introduced with primarily filtered water to secondarily filter the primarily filtered water.

Here, the water filter hole 154 is preferably formed to be smaller in size than the water inflow hole 152.

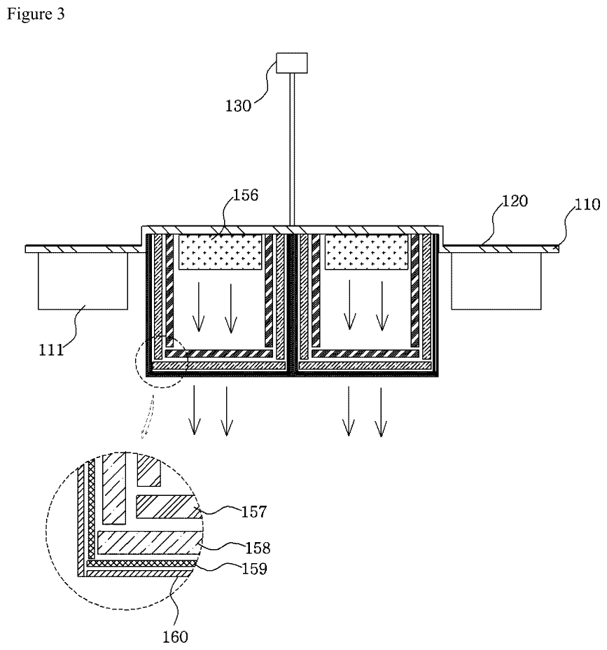

The water purification robot filter 155 is described below with reference to FIG. 3.

The water purification robot filter 155 is installed at a center of the lower portion of the base part 110 to be introduced with the secondarily filtered water through the filter pipe 153, filter the algae in the introduced water and purify the water, and then discharge the purified water to the reservoir.

In this case, as illustrated in FIG. 3, the water purification robot filter 155 includes a zeolite filter 156 that performs primary filtering by adsorbing algae contained in water introduced through the flow pipe 161 into pores of zeolite, a first filter sponge 157 that performs secondary filtering by absorbing the algae remaining in the primarily filtered water, a second filter sponge 158 that is formed of particles smaller than particles of the first filter sponge 157 and performs tertiary filtering by absorbing algae remaining in the secondarily filtered water, a non-woven filter 159 that performs quaternary filtering by re-absorbing algae remaining in the tertiarily filtered water, and a bag filter 160 that performs quinary filtering by filtering residual green remaining in the quaternarily filtered water.

The water purification robot filter 155 is preferably located in the order of the bag filter 160, the non-woven filter 159, the second filter sponge 158, and the first filter sponge 157 from the outside to the inside, and the zeolite filter 156 is preferably located on an upper side thereof.

In this case, the zeolite filter 156, the first filter sponge 157, and the second filter sponge 158 may be cleaned and reused every three months. In addition, the bag filter 160 and the non-woven filter 159 should be replaced and used every month.

Due to the water purification robot filter 155, the algae contained in water introduced through the water inflow case 151 or the filter pipe 153 may be removed, and the purified water may be discharged back into the reservoir.

Meanwhile, when the water purification robot filter 155 is installed at the center of the lower portion of the base part 110, it is preferable that the center of the base part 110 protrude more upward than an edge portion. The reason is that in order to allow the algae to remain in the zeolite of the zeolite filter 156, the position of the zeolite filter 156 should be higher than that of the water surface, and thus the center of the base part 110 where the water purification robot filter 155 is installed should be formed to protrude.

The flow pipe 161 connects the water purification robot filter 155 and the filter pipe 153 to introduce the secondarily filtered water. In other words, the flow pipe 161 is connected between the water purification robot filter 155 and the filter pipe 153 so that the secondarily filtered water is discharged to the zeolite filter 156 of the water purification robot filter 155 through the filter pipe 153.

In this case, it is preferable that the underwater pump 162 is formed between the flow pipe 161 and the filter pipe 153 to pump the water from the filter pipe 153 so that the water flows into the flow pipe 161.

It is preferable that the bumper part 170 be installed to be located on a surface where the algae removal unit 150 is not installed among the side surfaces of the base part 110. That is, it is preferable that the bumper part 170 be mounted on the non-installed surface among the side surfaces of the base part 110 where the water inflow case 151 of the algae removal unit 150 is installed.

The bumper part 170 is for protecting the algae removal units 150 and the like by buffering external impact that arises when the water purification robot 100 is autonomously driven.

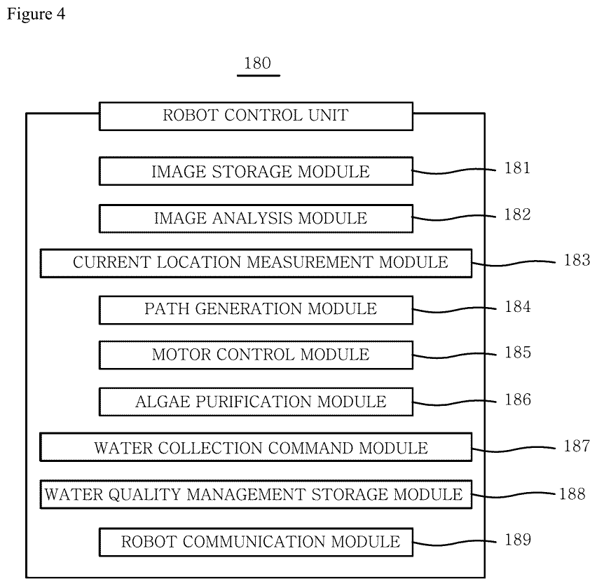

The robot control unit 180 will be described below with reference to FIG. 4.

The robot control unit 180 may include an image storage module 181 that receives and stores the water surface images and the underwater images, an image analysis module 182 that analyzes the water surface images and the underwater images and determines whether there are obstacles to generate obstacle information, a current location measurement module 183 that measures a current location through the GPS to generate current location information, a path generation module 184 that generates avoidance paths to autonomously be driven by avoiding the obstacles in a driving path using the current location information and the obstacle information, a motor control module 185 that drives the driving unit 140 to drive along the driving path and the avoidance paths, an algae purification module 186 that compares the water quality measurement data received from the water quality measurement module with the preset normal degree of algae concentration to operate the algae removal units 150, and a water collection command module 187 that generates a water collection command signal including information related to a water collection point and a water collection depth and transmits the generated water collection command signal to the water quality management unit 190.

The image storage module 181 receives and stores the water surface images and the underwater images from the image capturing module of the current situation unit 130. The water surface images and the underwater images may be accumulated and stored based on time.

In this case, the water surface images and the underwater images can also store the location information of the reservoir.

The image analysis module 182 analyzes the water surface images and the underwater images to determine whether there are obstacles.

The image analysis module 182 has a normal water surface image and a normal underwater image of a reservoir pre-stored therein and may determine whether there are obstacles by comparing and analyzing the water surface images and the underwater images with the normal water surface image and the normal underwater image.

The image analysis module 182 generates the obstacle information when it determines that there are obstacles and does not generate the obstacle information when it determines that there are no obstacles.

The current location measurement module 183 measures the current location through the GPS to generate the current location information.

The path generation module 184 has a driving path preset therein, and generates avoidance paths for avoiding obstacles using the current location information and the obstacle information. That is, the path generation module 184 analyzes the water surface images and the underwater images received in real time from the image capturing module of the current situation unit 130 and generates the avoidance path for avoiding obstacles according to the determined obstacle information, thereby resetting the driving path.

By configuring the path generation module 184, the water purification robot may be driven autonomously and set an optimal path for water quality purification

The motor control module 185 is for controlling the motor of the driving unit 140 and drives the driving unit 140 according to the driving path and the avoidance paths.

The algae purification module 186 compares the water quality measurement data received from the water quality measurement module with the preset normal degree of algae concentration.

The algae purification module 186 may operate the algae removal units 150 when the water quality measurement data exceeds the normal degree of algae concentration and may not operate the algae removal units 150 when the water quality measurement data is less than the normal degree of algae concentration.

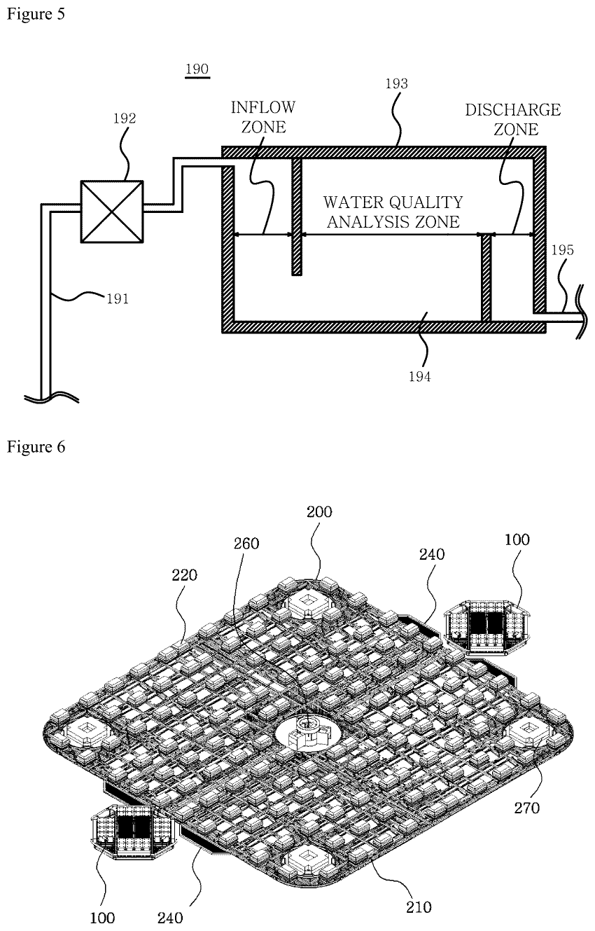

The water quality management unit 190 will be described below with reference to FIG. 5.

The water quality management unit 190 collects water from the water collection point and the water collection depth according to the water collection command signal when receiving the water collection command signal from the robot control unit 180 and then measures the water quality.

Since the water quality management unit 190 may measure the water quality after collecting the water from the water collection points and the water collection depths, it may measure accurate water temperature.

The water quality management unit 190 includes a suction pipe 191 having a predetermined length that suctions the water from the reservoir, a lift pump 192 that is connected to the suction pipe 191 for pumping the water, and a water collection tank 193 that has a water collection space formed to be filled with the water pumped from the suction pipe 191.

The water collection tank 193 has a plurality of baffles 194 that are formed on inner surfaces facing each other to alternately protrude toward the water collection space and partition the water collection space into an inflow zone, a water quality analysis zone, and a discharge zone.

The zones of the water collection tank 193 may be partitioned in the order of an inflow zone, a water quality analysis zone, and a discharge zone.

In this case, it is preferable that in the water collection tank 193, the baffle partitioning the inflow zone and the water quality analysis zone is formed to be longer than the baffle dividing the water quality analysis zone and the discharge zone.

In this case, one side of the water collection tank 193 is connected to the suction pipe 191 and water is introduced into the inflow zone.

Due to the formation of the inflow zone, foreign substances such as leaves present in water introduced through the suction pipe 191 may be removed, and the introduced water may be circulated later when moving to the water quality analysis zone.

The other side of the water collection tank 193 is connected to a drain pipe 195, and the water moving to the discharge zone may be discharged to the outside.

By forming the drain pipe 195, the water present from the water collection point and water collection depth in the water collection tank 193 may be drained.

As the water suctioned through the suction pipe 191 is introduced into the water collection tank 193, the water is filled in the order of the inflow zone, the water quality analysis zone, and the discharge zone.

Here, the water quality analysis zone is provided with a sensor for measuring water quality, a sensor for identifying algae species and the like and may further be provided with a sensor for measuring water quality to measure water temperature and the like.

That is, when the water quality analysis zone of the water collection tank 193 is filled with water, the water quality of the water and the algae species contained in the water may be measured and identified by the water quality measurement sensor and the algae species identification sensor, thereby generating water quality analysis data. In addition, the water in the water quality analysis zone may be stored as a sample.

Meanwhile, the robot control unit 180 may further include a water collection command module 187 that generates a water collection command signal including the information related to the water collection point and the water collection depth of the reservoir and then transmits the generated water collection command signal to the water quality management unit 190 and a water quality management storage module 188 that stores the water quality analysis data received from the water quality management unit 190.

The water collection command module 187 generates the water collection command signal including the information related to the water collection point and the water collection depth for measuring water quality in a reservoir, and when the water collection command signal is generated, transmits the generated water collection command signal to the water quality management unit 190.

In this case, the water collection command signal may further include a water collection time for water collection.

The accuracy of the water quality measurement may be improved with respect to the desired water collection point and water collection depth by the water collection command module 187.

The water quality management storage module 188 may also accumulate and store the water quality analysis data based on the water collection point and the water collection depth.

In addition, the robot control unit 180 may further include a robot communication module 189 for data communication.

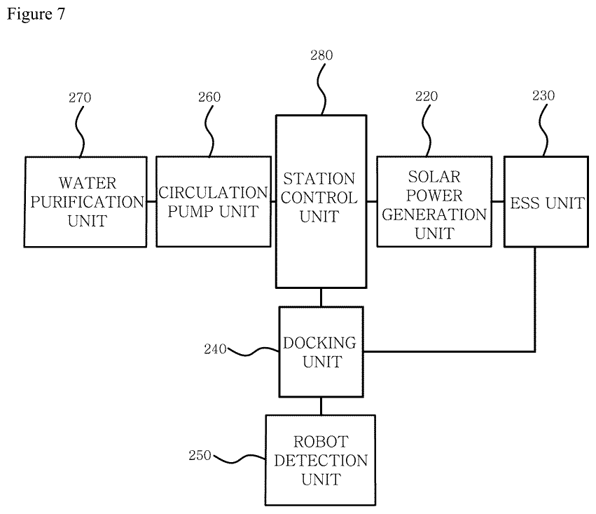

A station for a water purification robot for charging and unmanned management of the water purification robot 100 configured as described above will be described below with reference to FIGS. 6 and 7.

The station 200 for a water purification robot includes a station main body part 210 having a predetermined size, a solar power generation unit 220 that is installed on an upper surface of the station main body part 210 to convert sunlight into electrical energy and produce the electrical energy, an energy storage system ESS unit 230 that stores the electrical energy produced by the solar power generation unit 220, a docking unit 240 that includes a charging terminal that is formed on a side surface of the station main body part 210 and comes into contact with a charging socket of the water purification robot 100 to charge the water purification robot 100, a robot detection unit 250 that detects a docking status of the docking unit 240 and the water purification robot 100, and a station control unit 280 that generates a charging command signal according to whether the docking status of the water purification robot 100 is normal through the robot detection unit 250 and provides the generated charging command signal to the docking unit 240.

In addition, the station 200 for a water purification robot may include a circulation pump unit 260 that is connected to a suction pipe (not illustrated) for suctioning water from the reservoir to pump the water; and a water purification unit 270 that filters algae in the water suctioned through the circulation pump unit 260 and discharges purified water.

The main body part 210 in the station may be formed in a square shape and the like having a predetermined size, but is not limited thereto.

In addition, a plurality of floating bodies (not shown) should be formed on a lower surface of the station main body part 210 to float on the water surface of the reservoir.

The solar power generation unit 220 is installed on an upper surface of the station main body part 210 and is composed of a plurality of solar panels for converting sunlight into electrical energy.

In this case, the solar power generation unit 220 may further include a support frame for supporting the solar panels on the upper surface of the station main body part 210, and solar cells may be installed so that they have a predetermined inclination angle toward the sun to improve solar power generation efficiency.

Since the solar cells are installed so that they have a predetermined inclination angle, an area irradiated with sunlight may be maximized, which may help improve the solar power generation efficiency.

Meanwhile, the solar power generation unit 220 may further be provided with a hinge axis so that the solar cells may be rotatably connected to the support frame. Since the solar cells are rotatably connected to the support frame, the angle of the solar panels may be adjusted according to the altitude of the sun.

By adjusting the angle of the solar panels, the solar power generation efficiency may not only be significantly improved, but also the solar panels may be more easily managed, which can help reduce the operation and maintenance costs and provide an economical effect.

The ESS unit 230 stores the electrical energy produced from the solar panels. That is, the ESS unit 230 stores the electrical energy produced from the solar panels so that the water purification robot 100 may be charged in time, thereby stably supplying solar energy that is affected by the weather, time, etc.

By configuring the solar power generation unit 220 and the ESS unit 230, it is possible to operate the water purification robot in an environmentally-friendly manner while subsequently preventing the water purification robot from stoppage of operation.

The docking unit 240 may protrude from the side surface of the station main body part 210 and may be supplied with electrical energy from the ESS unit 230 to charge the water purification robot 100.

In this case, the docking unit 240 includes a charging terminal that comes into contact with the charging socket of the water purification robot 100 to charge the water purification robot 100.

When the water purification robot 100 is docked to the docking unit 240, the water purification robot 100 and the ESS unit 230 may be electrically connected, and the docking unit 240 may be supplied with electrical energy from the ESS unit 230 while the water purification robot 100 and the ESS unit 230 are electrically connected.

In addition, the docking unit 240 may be provided with a relay to control the electrical connection between the water purification robot 100 and the ESS unit 230. The relay may be maintained in an OFF state or switched from an ON state to an OFF state according to the control signal received from the station control unit 280.

Meanwhile, it is preferable that the docking unit 240 has the charging terminal provided at the center thereof and has a guide plate protruding outwardly formed on both sides of the charging terminal.

Since the docking unit 240 is formed to protrude, the water purification robot 100 may be guided to come into contact with the charging terminal, and damage caused by collision between the station main body part 210 and the water purification robot 100 may be prevented.

In addition, the docking unit 240 includes the robot detection unit 250 that detects the docking status of the water purification robot 100.

That is, the robot detection unit 250 is for detecting whether the charging socket of the water purification robot 100 comes into contact with the charging terminal of the docking unit 240 and preferably uses a detection sensor and the like.

Since it is possible to determine whether the charging socket of the water purification robot 100 properly comes into contact with the charging terminal of the docking unit 240 through the robot detection unit 250, it is possible to prevent the water purification robot 100 from not being charged and thus prevent unnecessary time consumption.

In addition, the robot detection unit 250 may detect whether the water purification robot 100 has entered the docking unit 240.

The circulation pump unit 260 is connected to the suction pipe (not illustrated) for suctioning water from a reservoir to pump the water and may be installed at the center of the station main body part 210.

In order to remove algae in water suctioned through the circulation pump unit 260, the water purification unit 270 should be configured. In this case, a connecting pipe (not illustrated) should be formed between the circulation pump unit 260 and the water purification unit 270 so that the water suctioned through the circulation pump unit 260 may flow to the water purification unit 270.

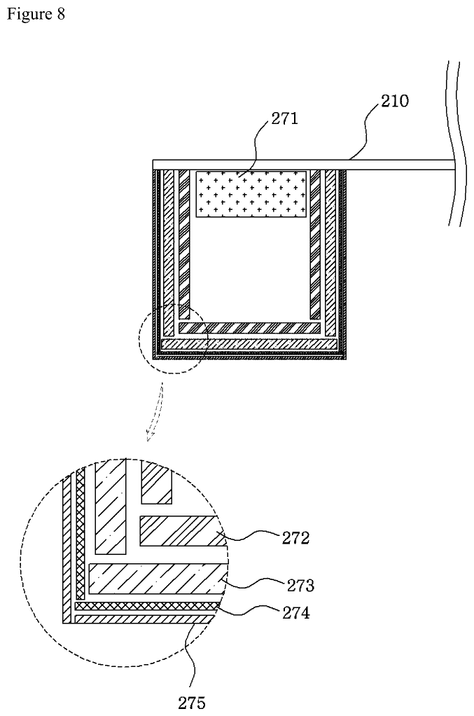

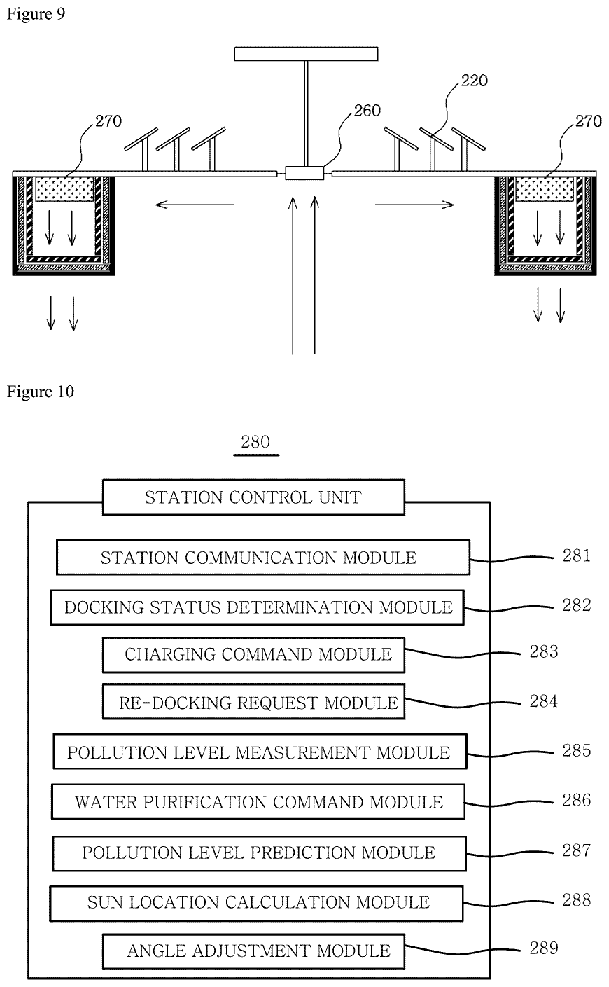

The water purification unit 270 will be described below with reference to FIGS. 8 and 9.

The water purification unit 270 is installed under the station main body part 210, and is positioned at a certain distance from the center of the circulation pump unit 260. That is, the plurality of water purification units 270 may be installed under the station main body part 210 and are preferably installed at each vertex of the station main body part 210.

The water purification unit 270 includes a station zeolite filter 271 that performs primary filtering by adsorbing algae contained in water and suctioned through the circulation pump unit 260 into pores of zeolite, a first filter sponge 272 that performs secondary filtering by absorbing the algae remaining in the primarily filtered water, a second filter sponge 273 that is formed of particles smaller than particles of the first filter sponge 272 and performs tertiary filtering by absorbing algae remaining in the secondarily filtered water, a fiber filter 274 that performs quaternary filtering by re-absorbing algae remaining in the tertiarily filtered water, and a filter dust collector 275 that performs quinary filtering by filtering residual algae remaining in the quaternarily filtered water.

The water purification unit 270 may be formed in a square cylinder shape, and a zeolite filter should be located on an upper surface thereof, and the first filter sponge 272 to the filter dust collector 275 should be overlappingly located on the side surfaces and the lower surface thereof.

In this case, when configuring the water purification unit 270, the filter dust collector 275 should be located at the outermost side thereof, and it is preferable that the fiber filter 274, the second filter sponge 273, and the first filter sponge 272 be located toward the inside thereof.

Meanwhile, the station zeolite filter 271, the first filter sponge 272, and the second filter sponge 273 may be cleaned and reused every three months. In addition, the filter dust collector 275 and the fiber filter 274 should be replaced and used every month.

Since the water purification unit 270 has been configured, the water purification unit 270 may pass the suctioned water through the station zeolite filter 271, primarily filter the algae, filter the algae as the suctioned water passes through the first filter sponge 272 and the filter dust collector 275, and then discharge the purified water back to the reservoir.

The station control unit 280 will be described below with reference to FIG. 10. The station control unit 280 may include a station communication module 281 that communicates with the water purification robot 100, a docking status determination module 282 that determines whether a docking status of the water purification robot 100 is normal based on whether a charging socket of the water purification robot 100 comes into contact with the charging terminal of the docking unit 240 through the robot detection unit 250, a charging command module 283 that generates a charging command signal and provides the generated charging command signal to the docking unit 240 when the docking status of the water purification robot 100 is normal, and a re-docking request module 284 that generates a re-docking request signal and provides the generated re-docking request signal to the water purification robot 100 when the docking status of the water purification robot 100 is abnormal.

The station communication module 281 is for communicating with the water purification robot 100 and may use a wireless network.

The docking status determination module 282 determines whether the docking status of the water purification robot 100 is normal based on whether the robot detection unit 250 detects that the charging socket of the water purification robot 100 has come into contact with the charging terminal of the docking unit 240.

The docking status determination module 282 determines that the docking status of the water purification robot 100 is normal when the robot detection unit 250 detects that the charging socket of the water purification robot 100 comes into contact with the charging terminal of the docking unit 240, and determines that the docking status of the water purification robot 100 is abnormal when the robot detection unit 250 detects that the charging socket of the water purification robot 100 has not come into contact with the charging terminal of the docking unit 240.

When the docking status determination module 282 determines that the docking status of the water purification robot 100 is normal, the docking status determination module 282 generates a charging command signal through the charging command module 283 and provides the generated charging command signal to the docking unit 240.

When the docking status determination module 282 determines that the docking status of the water purification robot 100 is abnormal, the docking status determination module 282 generates a re-docking request signal to induce the water purification robot 100 and the docking unit 240 to be re-docked through the re-docking request module 284 and provides the generated re-docking request signal to the water purification robot 100.

In this case, when the water purification robot 100 receives the re-docking request signal, the water purification robot 100 resets a path to the docking unit 240 and then operates to attempt to dock to the docking unit 240.

Since the re-docking request module 284 is configured, it is possible to prevent a situation where the water purification robot 100 is not charged, and as the water purification robot is easily managed, the waiting time for other water purification robots to be charged may be shortened.

Meanwhile, the station control unit 280 preferably includes a pollution level measurement module 285 that measures the water quality to generate a water pollution level, and a water purification command module 286 that generates a water purification command signal to drive the circulation pump unit 260 so as to suction the water from the reservoir when the generated water pollution level exceeds a preset normal water pollution level and transmits the generated water purification command signal to the circulation pump unit 260.

The pollution level measurement module 285 measures the water quality of the reservoir through a water quality measurement sensor for measuring the water quality of the reservoir and generates the water pollution level.

It is preferable that the pollution level measurement module 285 measure the water quality of the reservoir according to a preset measurement time. Accordingly, by periodically measuring the water quality of the reservoir, it becomes easy to manage the water quality of the reservoir and to quickly respond to the water pollution.

The water purification command module 286 should set the normal water pollution level of the reservoir in advance.

The water purification command module 286 generates a water quality purification command signal for driving the circulation pump unit 260 when the water pollution level generated by the pollution level measurement module 285 exceeds the normal water pollution level and transmits the generated water quality purification command signal to the circulation pump unit 260 and does not generate the water quality purification command signal when the water pollution level generated by the pollution level measurement module 285 is equal to or lower than the normal water pollution level.

In this case, the circulation pump unit 260 pumps the water of the reservoir when the water quality purification command signal is received.

By configuring the water purification command module 286, a manager may remove the inconvenience of having to drive the circulation pump unit 260 frequently, thereby efficiently managing the water quality of the reservoir.

In addition, the station control unit 280 may further include a pollution prediction module 287 that predicts whether the algae will emerge according to the degree of water pollution, predicting the emergence of algae according to pre-stored weather information for a current location and the water pollution level using pre-stored precursory information of an emergence of algae and generates water pollution prediction information and transmits the generated water pollution prediction information to the water purification command module 286.

The precursors of the emergence of algae, such as temperature, precipitation, and pollutant concentration suitable for the emergence of algae, may be derived through artificial intelligence and may be stored as, for example, the cases where the water temperature is 20° C. or higher, the precipitation is low, there has been sunlight for a long time, and the pollutant concentration is a chlorophyll-a concentration of 15 mg/m³ or more.

The weather information data may be received from the Korea Meteorological Administration server, and preferably includes precipitation, temperature, etc. of a pre-stored current location.

The pollution prediction module 287 determines that the probability of algae emergence is high when the weather information data and the water pollution level correspond to the precursor of the emergence of algae to generate water pollution prediction information and determines that the probability of algae emergence is low when the weather information data and the water pollution level do not correspond to the precursory information of the emergence of algae to not generate the water pollution prediction information.

When the water pollution prediction information is generated in the pollution prediction module 287, the water pollution prediction information is transmitted to the water purification command module 286. In this case, when receiving the water pollution prediction information, the water purification command module 286 generates the water quality purification command signal and provides the generated water quality purification command signal to the circulation pump unit 260.

Through the pollution prediction module 287, it is possible to prevent a large amount of algae in the reservoir in advance, which may help minimize the destruction of the ecosystem and the like.

On the other hand, the station control unit 280 may further include a sun location calculation module 288 that calculates an altitude and an azimuth of the sun through the pre-stored current location to generate sun location information, and an angle adjustment module 289 that generates a driving signal for adjusting an angle of the solar power generation unit 220 using the generated sun location information and provides the driving signal to the solar power generation unit 220.

The sun location calculation module 288 preferably has the pre-stored current location and may also receive current location information using GPS and the like.

The sun location calculation module 288 may generate sun location information by calculating the altitude and azimuth of the sun at regular time intervals through the current location. In this case, the sun location calculation module 288 may calculate the location of the sun through an algorithm already known to a person skilled in the art.

In addition, the sun location calculation module 288 may receive data on the altitude and azimuth of the sun based on location and time from the Korea Meteorological Administration server and may calculate the location of the sun for the current location.

The angle adjustment module 890 adjusts the angle of the solar power generation unit 220 according to the location information of the sun generated through the sun location calculation module 288. In other words, the angle adjustment module 289 generates a driving signal to adjust the angle of the solar panels according to the sun location information and provides the generated driving signal to the solar power generation unit 220.

It is preferable that the angle adjustment module 890 has the angle of the solar panel set in advance according to the location of the sun.

Since the sun location calculation module 288 and the angle adjustment module 890 are configured, the solar panels may be located to face the direction in which the sun is located, thereby greatly improving the solar power generation efficiency and providing economical power.

The station 200 for a water purification robot configured as described above may charge the water purification robot regardless of time or weather by storing electrical energy produced through the solar power generation in the ESS while floating on reservoirs and dams, thereby preventing accidents, such as the discharge of the water purification robot, in advance.

In addition, since the water purification robot is prevented from being discharged, by managing the water purification robot in the unmanned way, it is possible to improve the convenience of a manager thereof.

In addition, it is possible to help purify water quality by removing the algae contained in the water of the reservoirs, the dams, and the like and circulating the water help shorten the time for managing the water quality of a large area of water and help improve the efficiency of the water purification by purifying water twice.

In addition, by utilizing artificial intelligence to predict whether algae will emerge, it is possible to prepare for the emergence of the algae in advance, thereby reducing damage caused by the emergence of the algae.

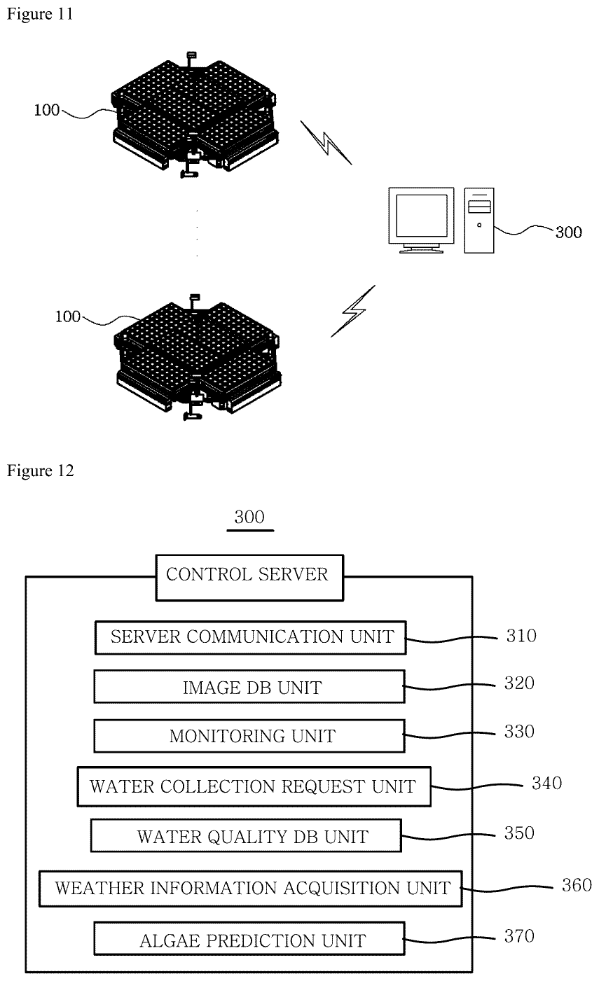

The smart water quality management system including the water purification robot 100 configured as above will be described below with reference to FIG. 11.

The smart water quality management system may include a control server 300 that receives and monitors the water quality measurement data from the water purification robot 100 and predicts whether the algae will emerge based on the water quality analysis data and the weather information data using the pre-stored precursor of the emergence of algae.

The control server 300 will be described below with reference to FIG. 12.

The control server 300 includes a server communication unit 310 that communicates with the water purification robot 100, an image database DB unit 320 that stores the water surface images and the underwater images received from the water purification robot 100 through the server communication unit 310, a monitoring unit 330 that receives and monitors the water quality measurement data from the water purification robot 100, a water collection request unit 340 that sets a water collection point and a water collection depth for collecting the water from a reservoir and transmits a generated water collection request signal to the water purification robot 100, a water quality DB unit 350 that stores water quality analysis data received from the water purification robot 100, a weather information acquisition unit 360 that acquires weather information data corresponding to location information of the reservoir, and an algae prediction unit 370 that predicts whether the algae will emerge by matching the water quality analysis data and weather information data with pre-stored precursory information of an emergence of algae and generates algae prediction information and transmits the generated algae prediction information to the water purification robot 100.

The server communication unit 310 may use a wireless network to communicate with the water purification robot 100.

The image DB unit 320 receives and stores the water surface images and the underwater images from the water purification robot 100.

It is preferable that the image DB unit 320 store and manage the water surface images and the underwater images according to time for each reservoir.

The monitoring unit 330 receives the water quality measurement data from the water purification robot 100 and monitors the received water quality measurement data in real time.

It becomes easy to manage the water quality of the reservoir by checking the water quality measurement data of the reservoir in real time through the monitoring unit 330, and the manager thereof may also manage the water quality of the reservoir by manually operating the water purification robot 100.

In addition, the monitoring unit 330 may receive and monitor the water surface images and the underwater images, so it is possible to quickly remove foreign substances and the like existing in the reservoir, which may help preserve the environment and reduce the inconvenience of the manager having to visit frequently, thereby easily managing the reservoir environment.

The water collection request unit 340 may request water collection in order to manage the water quality of the reservoir and generate a water collection request signal by setting the water collection point, the water collection depth, and the water collection time with respect to the reservoir. The generated water collection request signal is transmitted to the water purification robot 100.

In this case, when the water collection request signal sets the water collection time, changes in the water quality over time can be identified.

Meanwhile, the water purification robot 100 may receive the water collection request signal, generate the water collection command signal through the water collection command module 187 of the robot control unit 180, and operate the water quality management unit 190.

The water quality DB unit 350 stores and manages the water quality analysis data and the algae species data received from the water purification robot 100 that has measured the water quality by collecting the water from the reservoir through the water collection request unit 340 according to time for each reservoir.

Through the water quality DB unit 350, the water quality of the reservoir may be systematically managed, and accurate diagnosis and response may be made to the algae that emerges in the reservoir, thereby preventing a waste of manpower, resources, etc.

The weather information acquisition unit 360 generates the weather information request signal including the location information of the reservoir, transmits the generated weather information to the Korea Meteorological Administration server (not illustrated), and then acquires weather information data corresponding to the location information of the reservoir.

The weather information data should store temperature, precipitation, solar radiation, wind speed, etc.

The algae prediction unit 370 should have the pre-stored precursors of the emergence of algae.

The precursory information of the emergence of algae is the condition under which the algae emerges, and it is preferable that the water temperature, the solar radiation, the sunlight duration, the precipitation, and the pollutant concentration, etc., which may affect the emergence of algae, are stored.

The precursors of the emergence of algae are the case where the water temperature is 20° C. or higher, the precipitation is low, the sunlight duration is long, and the pollutant concentration is a chlorophyll-a concentration of 15 mg/m³ or more.

The algae prediction unit 370 predicts the emergence of algae to generate the algae prediction information when the water quality analysis data and the weather information data correspond to the precursors of the emergence of algae and determines that algae has not emerged when the water quality analysis data and the weather information data do not correspond to the precursors of the emergence of algae.

The algae prediction information generated in the algae prediction unit 370 may be transmitted to the water purification robot 100. In this case, the water purification robot 100 may operate the algae prediction information.

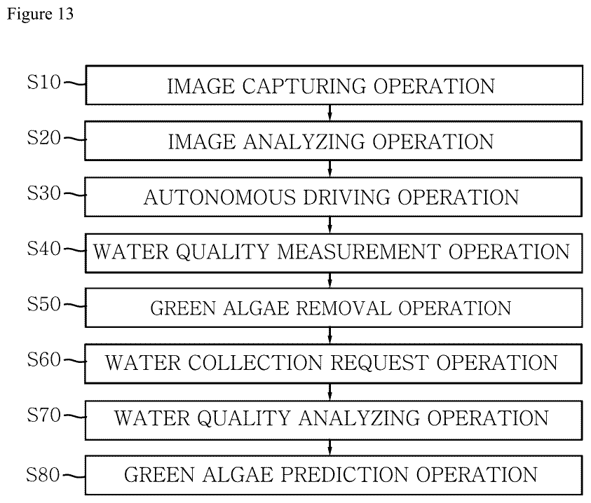

The method of managing water quality using the smart water quality management system as described above will be described below with reference to FIG. 13.

The water surface images and the underwater images are analyzed to determine whether there are obstacles. When there are obstacles, the obstacle information is generated and the avoidance paths are generated using the obstacle information, and when there are no obstacles, the obstacle information is not generated (S20).

The water purification robot 100 autonomously drives along the current location information extracted using the GPS and the preset driving path or the avoidance paths (S30).

The water purification robot 100 measures the water quality in real time to generate the water quality measurement data (S40).

When the water quality measurement data exceeds the preset normal degree of algae concentration, the water purification robot 100 introduces water into the algae removal units 150 according to the driving and filters the algae to discharge the purified water (S50). On the other hand, when the water quality measurement data does not exceed the preset normal degree of algae concentration, the water purification robot 100 may not operate the algae removal units 150.

The control server 300 transmits the water collection request signal, which sets the water collection point and the water collection depth, to the water purification robot 100 to request the water collection (S60).

The water purification robot 100 receives the water collection request signal and generates the water collection command signal through the robot control unit 180 and transmits the generated water collection command signal to the water quality management unit 190. Thereafter, after water is collected from the water collection point and the water collection depth through the water quality management unit 190, the water quality analysis data is generated by measuring the water quality and the identifying algae species and transmitted to the control server 300 (S70).

The control server 300 acquires the weather information data using the location information of the reservoir (S80).

In the case where the water quality analysis data and the weather information data correspond to the pre-stored precursors of the emergence of algae, the control server 300 predicts the emergence of algae to generate the algae prediction information and transmits the generated algae prediction information to the water purification robot 100 to operate the water purification robot 100 (S90). On the other hand, when the water quality analysis data and the weather information data do not correspond to the pre-stored precursors of the emergence of algae, it is determined that the algae does not emerge.

The smart water quality management system controlled as described above may move freely in all directions, i.e., frontward, backward, leftward, rightward, etc., using the water purification robot that can move autonomously in the reservoir, the dam, etc. so that a small number of devices may be used relative to the area of the reservoir or dam, which may be economical and efficient, and may remove the algae in the missed spots as well as areas at risk, thereby automating the water quality management and improving the water purification function.

In addition, it is possible to quickly respond to the algae while monitoring the water quality in the reservoir, the dam, etc. in real time.

In addition, by collecting the water at the water collection point and the water collection depth, it is possible to measure the water temperature and the like for the corresponding water depth and improve the reliability of the water quality measurement.

In addition, by utilizing big data to predict the emergence of the algae and collecting the initial response strategy to the algae, it is possible to minimize damage due to the algae and prevent the water pollution from spreading.

The embodiments of the present invention described above and illustrated in the drawings should not be construed as limiting the technical idea of the present invention. The protection scope of the present invention is limited only by the matters described in the claims, and those with ordinary knowledge in the technical field of the present invention can improve and change the technical idea of the present invention in various forms. Accordingly, such improvements and changes will fall within the protection scope of the present invention if they are obvious to those with ordinary knowledge in the technical field of the present invention.

1. A water purification robot comprising:
a current situation unit (130) that includes an image capturing module mounted on a base part (110) floating on a water surface of a reservoir to capture a water surface image and an underwater image and a water quality measurement module for measuring water quality of the reservoir;
a driving unit (140) that is mounted under the base part (110) and includes four motors for driving that allow a directional change to be made in all directions;
an algae removal unit (150) that filters algae in water introduced by the driving of the driving unit (140) and discharges purified water; and
a robot control unit (180) that controls the driving unit (140) by analyzing the water surface image and the underwater image while driving along a preset driving path to generate an avoidance path according to whether there is an obstacle, and controls the algae removal unit (150) by comparing water quality measurement data with a preset normal degree of algae concentration.

2. The water purification robot of claim 1, wherein the algae removal unit (150) includes water inflow cases (151) having a predetermined length that are installed on each side surface of the base part (110) to introduce the water containing the algae into a plurality of water inflow holes (152) formed in a longitudinal direction and primarily filter the water, a filter pipe (153) having a predetermined length that is installed in the water inflow case (151) and provided with the plurality of water inflow holes (152) to introduce the primarily filtered water and secondarily filters the primarily filtered water, a water purification robot filter (155) that is installed under the base part (110) to filter the algae in the secondarily filtered water and discharge the purified water into the reservoir, and a flow pipe (161) that connects the water purification robot filter (155) and the filter pipe (153) to introduce the secondarily filtered water.

3. The water purification robot of claim 1, further comprising a water quality management unit (190) that collects water from a preset water collection point and water collection depth and analyzes water quality,
wherein the water quality management unit (190) includes a suction pipe (191) having a predetermined length that suctions the water from the reservoir, a lift pump (192) that is connected to the suction pipe (191) for pumping the water, and a water collection tank (193) that has a water collection space formed to be filled with the water pumped from the suction pipe (191), and
the water collection tank (193) has a plurality of baffles (194) that are formed on inner surfaces facing each other to alternately protrude toward the water collection space and partition the water collection space into an inflow zone, a water quality analysis zone, and a discharge zone.

4. The water purification robot of claim 2, further comprising a water quality management unit (190) that collects water from a preset water collection point and water collection depth and analyzes water quality,
wherein the water quality management unit (190) includes a suction pipe (191) having a predetermined length that suctions the water from the reservoir, a lift pump (192) that is connected to the suction pipe (191) for pumping the water, and a water collection tank (193) that has a water collection space formed to be filled with the water pumped from the suction pipe (191), and
the water collection tank (193) has a plurality of baffles (194) that are formed on inner surfaces facing each other to alternately protrude toward the water collection space and partition the water collection space into an inflow zone, a water quality analysis zone, and a discharge zone.

5. The water purification robot of claim 1, wherein the robot control unit (180) further includes a water quality management unit (190) that generates a water collection command signal including information related to a water collection point and a water collection depth of the reservoir and collects the water according to the water collection command signal received from the robot control unit (180) to analyze the water quality,
the water quality management unit (190) includes a suction pipe (191) having a predetermined length that suctions the water from the reservoir, a lift pump (192) that is connected to the suction pipe (191) for pumping the water, and a water collection tank (193) that has a water collection space formed to be filled with the water pumped from the suction pipe (191), and
the water collection tank (193) has a plurality of baffles (194) that are formed on inner surfaces facing each other to alternately protrude toward the water collection space and partition the water collection space into an inflow zone, a water quality analysis zone, and a discharge zone.

6. The water purification robot of claim 2, wherein the robot control unit (180) further includes a water quality management unit (190) that generates a water collection command signal including information related to a water collection point and a water collection depth of the reservoir and collects the water according to the water collection command signal received from the robot control unit (180) to analyze the water quality,
the water quality management unit (190) includes a suction pipe (191) having a predetermined length that suctions the water from the reservoir, a lift pump (192) that is connected to the suction pipe (191) for pumping the water, and a water collection tank (193) that has a water collection space formed to be filled with the water pumped from the suction pipe (191), and
the water collection tank (193) has a plurality of baffles (194) that are formed on inner surfaces facing each other to alternately protrude toward the water collection space and partition the water collection space into an inflow zone, a water quality analysis zone, and a discharge zone.

7. The water purification robot of claim 5, wherein the robot control unit (180) includes an image storage module (181) that receives and stores the water surface image and the underwater image, an image analysis module (182) that analyzes the water surface image and the underwater image and determines whether there is the obstacle to generate obstacle information, a current location measurement module (183) that measures a current location through a global positioning system (GPS) to generate current location information, a path generation module (184) that generates an avoidance path to autonomously be driven by avoiding the obstacle in a driving path using the current location information and the obstacle information, a motor control module (185) that drives the driving unit (140) to drive along the driving path and the avoidance path, an algae purification module (186) that compares the water quality measurement data received from the water quality measurement module with the preset normal degree of algae concentration to operate the algae removal unit (150), a water collection command module (187) that generates a water collection command signal including information related to a water collection point and a water collection depth and transmits the generated water collection command signal to the water quality management unit (190), and a water quality management storage module (188) that stores water quality analysis data received from the water quality management unit (190).

8. The water purification robot of claim 6, wherein the robot control unit (180) includes an image storage module (181) that receives and stores the water surface image and the underwater image, an image analysis module (182) that analyzes the water surface image and the underwater image and determines whether there is the obstacle to generate obstacle information, a current location measurement module (183) that measures a current location through a global positioning system (GPS) to generate current location information, a path generation module (184) that generates an avoidance path to autonomously be driven by avoiding the obstacle in a driving path using the current location information and the obstacle information, a motor control module (185) that drives the driving unit (140) to drive along the driving path and the avoidance path, an algae purification module (186) that compares the water quality measurement data received from the water quality measurement module with the preset normal degree of algae concentration to operate the algae removal unit (150), a water collection command module (187) that generates a water collection command signal including information related to a water collection point and a water collection depth and transmits the generated water collection command signal to the water quality management unit (190), and a water quality management storage module (188) that stores water quality analysis data received from the water quality management unit (190).

9. A station for a water purification robot, comprising:
a station main body part (210) having a predetermined size;
a solar power generation unit (220) that is installed on an upper surface of the station main body part (210) to convert sunlight into electrical energy and produce the electrical energy;
an energy storage system (ESS) unit (230) that stores the electrical energy produced by the solar power generation unit (220);
a docking unit (240) that includes a charging terminal that is formed on a side surface of the station main body (210) and comes into contact with a charging socket of the water purification robot (100) to charge the water purification robot (100);
a robot detection unit (250) that detects a docking status of the docking unit (240) and the water purification robot (100); and
a station control unit (280) that generates a charging command signal according to whether the docking status of the water purification robot (100) is normal through the robot detection unit (250) and provides the generated charging command signal to the docking unit (240),
wherein the water purification robot (100) includes a current situation unit (130) that includes an image capturing module mounted on a base part (110) floating on a water surface of a reservoir to capture a water surface image and an underwater image and a water quality measurement module for measuring water quality of the reservoir, a driving unit (140) that is mounted under the base part (110) and includes four motors for driving that allow a directional change to be made in all directions, an algae removal unit (150) that filters algae in water introduced by the driving of the driving unit (140) and discharges purified water, and a robot control unit (180) that controls the driving unit (140) by analyzing the water surface image and the underwater image while driving along a preset driving path to generate an avoidance path according to whether there is an obstacle, and controls the algae removal unit (150) by comparing water quality measurement data with a preset normal degree of algae concentration.

10. The station of claim 9, wherein the station control unit (280) includes:
a station communication module (281) that communicates with the water purification robot (100);
a docking status determination module (282) that determines whether the docking status of the water purification robot (100) is normal based on whether the charging socket of the water purification robot (100) is in contact with the charging terminal of the docking unit (240) through the robot detection unit (250);
a charging command module (283) that generates a charging command signal and provides the generated charging command signal to the docking unit (240) when the docking status of the water purification robot (100) is normal; and
a re-docking request module (284) that generates a re-docking request signal and provides the generated re-docking request signal to the water purification robot (100) when the docking status of the water purification robot (100) is abnormal.

11. The station of claim 9, further comprising:
a circulation pump unit (260) that is connected to a suction pipe for suctioning water from the reservoir to pump the water; and
a water purification unit (270) that filters algae in the water suctioned through the circulation pump unit (260) and discharges purified water.

12. The station of claim 10, further comprising:
a circulation pump unit (260) that is connected to a suction pipe for suctioning water from the reservoir to pump the water; and
a water purification unit (270) that filters algae in the water suctioned through the circulation pump unit (260) and discharges purified water.

13. The station of claim 11, wherein the station control unit (280) includes a pollution level measurement module (285) that measures the water quality of the reservoir to generate a water pollution level, and a water purification command module (286) that generates a water purification command signal to drive the circulation pump unit (260) so as to suction the water from the reservoir when the generated water pollution level exceeds a preset normal water pollution level and transmits the generated water purification command signal to the circulation pump unit (260).

14. The station of claim 12, wherein the station control unit (280) includes a pollution level measurement module (285) that measures the water quality of the reservoir to generate a water pollution level, and a water purification command module (286) that generates a water purification command signal to drive the circulation pump unit (260) so as to suction the water from the reservoir when the generated water pollution level exceeds a preset normal water pollution level and transmits the generated water purification command signal to the circulation pump unit 260.

15. The station of claim 13, wherein the station control unit (280) includes a pollution prediction module (287) that predicts whether the algae will emerge according to pre-stored weather information for a current location and the water pollution level using pre-stored precursory information of an emergence of algae and generates water pollution prediction information and transmits the generated water pollution prediction information to the water purification command module (286).

16. The station of claim 14, wherein the station control unit (280) includes a pollution prediction module (287) that predicts whether the algae will emerge according to the degree of water pollution, predicting the emergence of algae according to pre-stored weather information for a current location and the water pollution level using pre-stored precursory information of an emergence of algae, and generates water pollution prediction information and transmits the generated water pollution prediction information to the water purification command module (286).

17. The station of claim 15, wherein the solar power generation unit (220) further includes a plurality of solar cells, a support frame that supports the solar panels, and a hinge axis that connects the solar cells and the support frame so that the solar cells are rotatably connected to the support frame, and
the station control unit (280) includes a sun location calculation module (288) that calculates an altitude and an azimuth of the sun through the pre-stored current location to generate sun location information, and an angle adjustment module (289) that generates a driving signal for adjusting an angle of the solar power generation unit (220) using the generated sun location information and provides the driving signal to the solar power generation unit (220).

18. The station of claim 16, wherein the solar power generation unit (220) further includes a plurality of solar cells, a support frame that supports the solar panels, and a hinge axis that connects the solar cells and the support frame so that the solar cells are rotatably connected to the support frame, and
the station control unit (280) includes a sun location calculation module (288) that calculates an altitude and an azimuth of the sun through the pre-stored current location to generate sun location information, and an angle adjustment module (289) that generates a driving signal for adjusting an angle of the solar power generation unit (220) using the generated sun location information and provides the driving signal to the solar power generation unit (220).

19. A smart water quality management system comprising:
a control server (300) that monitors water quality measurement data of a reservoir and predicts whether algae will emerge according to water quality analysis data and weather information data using pre-stored precursory information of an emergence of algae to generate algae prediction information; and
a water purification robot (100) that generates water quality measurement data to be transmitted to the control server (300), sets a driving path in advance for driving according to the algae prediction information through current location information, includes an avoidance path in the preset driving path according to whether there is an obstacle by capturing a water surface image and an underwater image of the reservoir, and filters the algae in the water introduced while autonomously driving along the driving route and discharges purified water,
wherein the water purification robot (100) includes a current situation unit (130) that includes an image capturing module mounted on a base part (110) floating on a water surface of a reservoir to capture a water surface image and an underwater image and a water quality measurement module for measuring water quality of the reservoir, a driving unit (140) that is mounted under the base part (110) and includes four motors for driving that allow a directional change to be made in all directions, an algae removal unit (150) that filters algae in water introduced by the driving of the driving unit (140) and discharges purified water, and a robot control unit (180) that controls the driving unit (140) by analyzing the water surface image and the underwater image while driving along a preset driving path to generate an avoidance path according to whether there is an obstacle, and controls the algae removal unit (150) by comparing water quality measurement data with a preset normal degree of algae concentration.

20. The smart water quality management system of claim 19, wherein the water purification robot (100) includes a base part (110) that floats on the surface of the reservoir, a solar panel part (120) that is installed above the base part (110) to convert sunlight into electrical energy, a bumper part (170) that is installed on the base part (110) to be located between the algae removal unit (150) and buffers external impact, a robot control unit (180) that generates a water collection command signal including information related to a water collection point and a water collection depth of the reservoir, and a water quality management unit (190) that collects water from the water collection point and the water collection depth according to the water collection command signal received from the robot control unit (180) and analyzes water quality.

21. The smart water quality management system of claim 20, wherein the algae removal unit (150) includes water inflow cases (151) having a predetermined length that are installed on each side surface of the base part (110) to introduce the water containing the algae into a plurality of water inflow holes (152) formed in a longitudinal direction and primarily filter the water, a filter pipe (153) having a predetermined length that is installed in the water inflow case (151) and provided with the plurality of water inflow holes (152) to introduce the primarily filtered water and secondarily filters the primarily filtered water, a water purification robot filter (155) that is installed under the base part (110) to filter the algae in the secondarily filtered water and discharge the purified water into the reservoir, and a flow pipe (161) that connects the water purification robot filter (155) and the filter pipe (153) to introduce the secondarily filtered water.

22. The smart water quality management system of claim 20, wherein the robot control unit (180) includes an image storage module (181) that receives and stores the water surface image and the underwater image, an image analysis module (182) that analyzes the water surface image and the underwater image and determines whether there is the obstacle to generate obstacle information, a current location measurement module (183) that measures a current location through a global positioning system (GPS) to generate current location information, a path generation module (184) that generates an avoidance path to autonomously be driven by avoiding the obstacle in a driving path using the current location information and the obstacle information, a motor control module (185) that drives the driving unit (140) to drive along the driving path and the avoidance path, an algae purification module (186) that compares the water quality measurement data received from the water quality measurement module with the preset normal degree of algae concentration to operate the algae removal unit (150), a water collection command module (187) that generates a water collection command signal including information related to a water collection point and a water collection depth and transmitting the generated water collection command signal to the water quality management unit (190), and a water quality management storage module (188) that stores water quality analysis data received from the water quality management unit (190).

23. The smart water quality management system of claim 21, wherein the robot control unit (180) includes an image storage module (181) that receives and stores the water surface image and the underwater image, an image analysis module (182) that analyzes the water surface image and the underwater image and determines whether there is the obstacle to generate obstacle information, a current location measurement module (183) that measures a current location through a global positioning system (GPS) to generate current location information, a path generation module (184) that generates an avoidance path to autonomously be driven by avoiding the obstacle in a driving path using the current location information and the obstacle information, a motor control module (185) that drives the driving unit (140) to drive along the driving path and the avoidance path, an algae purification module (186) that compares the water quality measurement data received from the water quality measurement module with the preset normal degree of algae concentration to operate the algae removal unit (150), a water collection command module (187) that generates a water collection command signal including information related to a water collection point and a water collection depth and transmitting the generated water collection command signal to the water quality management unit (190), and a water quality management storage module (188) that stores water quality analysis data received from the water quality management unit (190).

24. The smart water quality management system of claim 20, wherein the control server (300) includes a server communication unit (310) that communicates with the water purification robot (100), an image database (DB) unit (320) that stores the water surface image and the underwater image received from the water purification robot (100) through the server communication unit (310), a monitoring unit (330) that displays and monitors the stored water surface image and underwater image, a water collection request unit (340) that sets the water collection point and the water collection depth for collecting the water from the reservoir and transmits a generated water collection request signal to the water purification robot (100), a water quality DB unit (350) that stores water quality analysis data received from the water purification robot (100), a weather information acquisition unit (360) that acquires weather information data corresponding to location information of the reservoir, and an algae prediction unit (370) that predicts whether the algae emerges by matching the water quality analysis data and weather information data with pre-stored precursory information of an emergence of algae and generates algae prediction information and transmit the generated algae prediction information to the water purification robot (100).
